(19) United States
(12) Patent Application Publication
(10) Pub. No.: US 2006/0246259 A1
(43) Pub. Date: Nov. 2, 2006

(54) Wallpaper manufacture method and its wallpaper products

(76) Inventor: Ching-Tien Chen, Tainan County (TW)

Correspondence Address: BIRCH STEWART KOLASCH & BIRCH, PO BOX 747, FALLS CHURCH, VA, 22040-0747, US

(21) Appl. No.: 11/117,464

(22) Filed: Apr. 29, 2005

(51) Int. Cl. B32B 3/00

(52) U.S. Cl. 428/156; 428/195.1

(57) ABSTRACT

The present invention discloses a wallpaper manufacturing method and its wallpaper products, in which a thermoplastic polyurethane (TPU) material is coated onto an external surface of a glass reinforced plastic (ERP) cloth and heated to a temperature of 100-200° C. and then pressed by a roller to produce and print desired patterns, so that the surface of the FRP cloth is protected by a protective film made of the TPU material, and finally fused into a wallpaper product by applying heat and pressure. The wallpaper not only has an artistic look, but also has the environmental protection feature and achieves the ultraviolet-resisting, antiseptic, soundproof, fireproof, and thermal insulating functions.

### FIELD OF THE INVENTION

The present invention generally relates to wallpapers, and more specifically to a wallpaper manufacture method and its wallpaper products, wherein the wallpaper is produced by coating a thermoplastic polyurethane (TPU) material onto the surface of a fiberglass reinforced plastic (FRP) cloth and then fusing the TPU with the FRP cloth by applying heat and pressure.

### BACKGROUND OF THE INVENTION

In general, the wallpaper used for interior decorations is made of a combusting-supporting material, and the wallpaper of this type attached on the walls of a building not only fails to prevent fire, but also causes damages to the building and injuries to people easily, when a fire accident occurs. Since the wallpaper is inflammable, it helps combustions and causes continuous flames, when a fire accident occurs. What is more, a fire source starts burning the wallpaper from its bottom to its top rapidly, or even from the wallpaper on a wall to the furniture, decoration, or other floor in the building, and that will create a more serious disaster.

It is obvious that the practicability of the foregoing prior art wallpaper cannot protect our life and safety, and thus demanding immediate attentions and improvements.

To overcome the aforementioned shortcomings of the prior art, manufacturers use continuous reinforced materials to produce wallpapers. The reinforced materials are made by dipping the material in a thermal epoxy resin and then dried, so that the thermal epoxy resin is hardened to a Class B (semi-melted stage) laminating material.

The abovementioned Class B refers to a reaction of a certain thermal epoxy resin, wherein the material will be expanded but not dissolved when it is in contact with an ethanol solution or an acetone solution, and the material will be softened to a diluted rubber form but will not be melted completely when it is heated. A general thermal epoxy resin is melted into a paint and dipped into a FRP cloth.

A FRP cloth strip made by the latest improved loom and using air jet for the production is used as the laminating material, but the following technical issues still remain:

1. The FRP strip contains excessive glue on the FRP cloth, and thus having a larger thickness than other part. If the laminating material of the FRP cloth with a larger thickness is cut into the desired length and the FRP clothes are stacked, the height of the laminating material will be higher and produces an uneven height for the overall appearance.

2. The shape of the cloth cannot be linear but is in a wavy shape, therefore both ends along the width of the laminating material are wavy in shape when viewing along its length. Even if the laminating material of this type is cut into a predetermined length and weight, their edges still cannot be cut even.

3. If it is necessary to have even edges on both sides, the wavy portion must be cut, and the cut portion may be mixed into the laminating material and results in a defective product.

The foregoing problems occurred during the manufacture of a laminating material for the FRP cloth may happen in the manufacture of a FRP cloth by a shuttle type loom.

To overcome problems (1) and (2) as described above, a method of cutting the cloth is adopted after the laminating material is formed, but such method still cannot solve the problem (3) as described above. Furthermore, the yield rate of the FRP cloth and paint will be lowered, and thus such method does not comply with cost requirements and economic effects.

In the aforementioned method, the edges of the FRP cloth can be cut before producing the laminating material from the FRP cloth, but there is no appropriate method introduced so far. For example, the Japan Laid-Open Patent Publication No. 52-34094 has disclosed a method of cutting a FRP cloth strip along a longitudinal direction into smaller pieces of FRP cloth strips, so that the cut section can be coated by a decorative edge made of a propylene, vinyl acetate copolymer, rubber or polyvinyl chloride adhesive and preferably coated with a polyester resin and the compatible vinyl acetate adhesive. However, it is questionable whether or not the laminating material with a narrower width produced by this method is applicable. Even the edges of the cloth are removed, this method still cannot produce a good laminating material without having the foregoing problems.

Further, the method disclosed in Japan Patent No. 48-18568 cannot provide a good laminating material by cutting the weaving tissues of a general fabric and woven cloth and adhering a synthetic resin by heat and dipping the cut section.

### SUMMARY OF THE INVENTION

The primary objective of the present invention is to overcome the shortcomings of the prior art by providing a wallpaper manufacture method that coats and glues a TPU material onto a FRP cloth, the TPU and FRP cloth are fused by applying heat and pressure to produce a wallpaper that can comply with the environmental protection requirements and achieve the ultraviolet resisting, antiseptic, soundproof, fireproof, waterproof and thermal insulating functions.

Therefore, the wallpaper of the present invention is made by coating and gluing a TPU material onto a FRP cloth, and the TPU material and FRP cloth are heated to a temperature of 100˜200° C. and then pressed by a roller to produce and print desired patterns. A protective film formed by gluing the TPU material on the surface of the FRP cloth is fused by applying heat and pressure to produce the wallpaper product.

### BRIEF DESCRIPTION OF THE DRAWINGS

FIG. 1 is a manufacture flow chart of the present invention;

FIG. 2 is a perspective view of a fiberglass reinforced plastic (FPR) cloth of the present invention;

FIG. 3 is a schematic view of a coated fiberglass reinforced plastic (FPR) cloth of the present invention; and

FIG. 4 is a perspective view of wallpaper products of the present invention.

### DETAILED DESCRIPTION OF THE PREFERRED EMBODIMENTS

To make it easier for our examiner to understand the objective of the invention, its structure, innovative features, and performance, we use a preferred embodiment and the attached drawings for the detailed description of the invention.

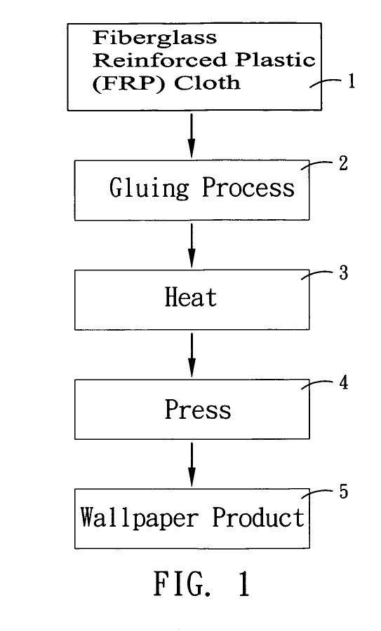

Referring to FIG. 1, the wallpaper manufacture method in accordance with the present invention comprises the steps of:

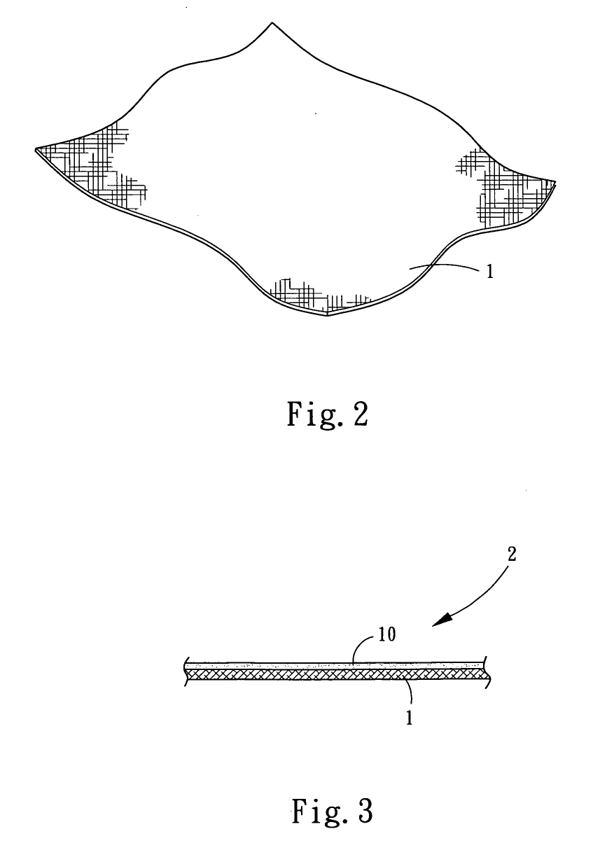

(a) Fiberglass Reinforced Plastic (FRP) Cloth 1: coating a thermal polyurethane (TPU) material 10 onto an external surface of the FRP cloth to form a sheet of FRP cloth 1 with a predetermined size as shown in FIG. 2;

(b) Gluing Process 2: The TPU material 10 is coated on the surface of the FRP cloth 1 for the gluing process 2 as shown in FIG. 3;

(c) Heat 3: The FRP cloth 1 coated with the TPU material 10 and gone through the gluing process 2 is heated to a temperature of 100˜200° C.;

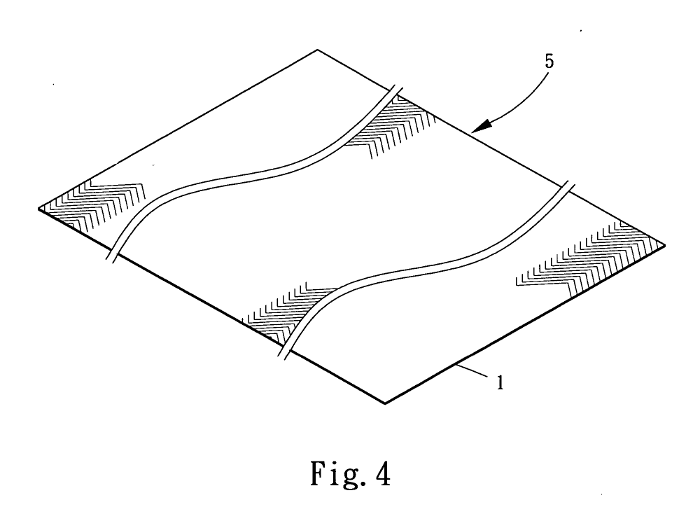

(d) Press 4: The heated FRP cloth 1 is pressed by a roller to form and print various different patterns 11 on the surface of the FRP cloth, and then the protective film produced by gluing the TPU material 10 onto the surface of the FRP cloth 1 is heated 3 and pressed 4 to be fused into a wallpaper product 5 as shown in FIG. 4, and the wallpaper product 5 has an artistic look and complies with the environmental protection requirements and achieves the ultraviolet resisting, antiseptic, soundproof, fireproof, waterproof and thermal insulating functions.

It is worth pointing out that the wallpaper produced by the present invention not only complies with the environmental protection requirements, but also has an excellent tenacity for its structure.

Therefore, the invention breaks through the material structure of traditional wallpapers as well as achieving better practicability and convenience.

In view of the description above, the present invention has the following advantages:

1. The wallpaper of the invention meets the environmental protection requirement and thus will not cause pollutions to the environment.

2. The wallpaper of the invention has an artistic look and excellent visual effect, which are add-on values to the wallpaper.

3. The wallpaper of the invention has excellent tenacity, secured structure and a low damage rate.

4. The invention complies with the production values and has a high economic benefit.

The present invention meets the patent application requirements and overcomes the shortcomings of the prior art wallpaper, and is thus a great creation.

What is claimed is:

1. A wallpaper manufacture method, comprising the steps of:
preparing a fiberglass reinforced plastic (FRP) cloth with a thermoplastic polyurethane (TPU) material coated onto an external surface of said FRP cloth;
performing a gluing process by coating a TPU material onto the external surface of said FRP cloth;
heating said FRP cloth coated with said TPU material to a temperature of 100˜200° C.; and
pressing said heated FRP cloth by a roller to produce and print various different patterns on the surface of said FRP cloth, and fusing a protective film produced by gluing said TPU material onto the surface of said FRP cloth by heating and pressing, so as to produce a wallpaper product.

2. A wallpaper product produced according to said wallpaper manufacture method as cited in claim 1, wherein the wallpaper product has a pattern on its surface or comes with a predetermined size.
